(19) United States
(12) Patent Application Publication
(10) Pub. No.: US 2021/0234418 A1
(43) Pub. Date: Jul. 29, 2021

(54) TWO DEGREE-OF-FREEDOM HIGH TILT TORQUE MOTOR, SYSTEM, AND AERIAL VEHICLE INCORPORATING THE SAME

(71) Applicant: HONEYWELL INTERNATIONAL INC., Charlotte, NC (US)

(72) Inventors: Deepak Mahajan, Bangalore (IN); Renukaprasad N, Bangalore (IN); Sivanagamalleswara Bavisetti, Bangalore (IN); Subhashree Rajagopal, Bangalore (IN)

(73) Assignee: HONEYWELL INTERNATIONAL INC., Charlotte, NC (US)

(21) Appl. No.: 17/092,534

(22) Filed: Nov. 9, 2020

(30) Foreign Application Priority Data
Jan. 27, 2020 (IN) 202011003532

(51) Int. Cl. H02K 1/27; B64C 39/02; H02K 1/17

(52) U.S. Cl. CPC H02K 1/27; B64C 39/024; H02K 2201/18; B64C 2201/042; B64C 2201/027; H02K 1/17

(57) ABSTRACT

A two degree-of-freedom motor includes an inner stator, a plurality of inner stator windings, an inner rotor, an outer stator, a plurality of outer stator windings, an outer rotor, and a shaft. The inner rotor is spaced apart from, and at least partially surrounds, the inner stator, and includes a plurality of magnets. The outer stator is spaced apart from, and at least partially surrounds, the inner stator and the inner rotor. The outer rotor is spaced apart from, and is disposed between, the inner rotor and the outer stator, and has a plurality of outer rotor projections. The shaft is coupled to the inner rotor and the outer rotor.

### CROSS REFERENCE TO RELATED APPLICATION

The present application claims benefit of prior filed Indian Provisional Patent Application No. 202011003532, filed Jan. 27, 2020, which is hereby incorporated by reference herein in its entirety.

### TECHNICAL FIELD

The present invention generally relates to multi degree-of-freedom motors, and more particularly relates to two degree-of-freedom high tilt torque motors, systems, and aerial vehicles that incorporate the same.

### BACKGROUND

Recent developments in the field of UAV (Unmanned Aerial Vehicles), drones for unmanned air transport, robotics, office automation, and intelligent flexible manufacturing and assembly systems have necessitated the development of precision actuation systems with multiple degrees of freedom (DOF). Conventionally, applications that rely on multiple (DOF) motion have typically done so by using a separate motor/actuator for each axis, which results in complicated transmission systems and relatively heavy structures.

With the advent of spherical motors, there have been multiple attempts to replace the complicated multi-DOF assembly with a single spherical motor assembly. A typical spherical motor consists of a central sphere on which coils are wound, which may be orthogonally placed from each other. The sphere is surrounded by multi-pole magnets in the form of an open cylinder. The coil assembly is held axially and maintained in a vertical position via, for example, a metal post. The outer cylinder is held by a yoke/frame via a bearing, which allows the cylinder to be rotatable about its axis. The yoke is further connected to the metal post of the coil assembly via a second bearing, which allows the yoke, along with the cylinder, to be rotatable about one or two additional axes.

Unfortunately, current attempts to apply the spherical motor to the certain applications, such as UAVs and robotics, have led to several spherical motor design concepts. Unfortunately, many of these design concepts suffer certain drawbacks. For example, many exhibit relatively limited torque and precise positioning, especially in the tilt axis. This is due, at least in part, to a relatively large air gap between the magnets and inner spherical stator (due in part to the windings) and a relatively heavy spherical stator. The current concepts also exhibit relatively high winding temperatures, relatively complicated and time-consuming winding patterns,

Hence, there is a need for a multi-degree-of-freedom electromagnetic machine that at least exhibits improved generated torque and position precision—especially in the tilt axis, improved thermal handling capabilities, improved speed range, and simpler coil winding configurations as compared to presently known spherical motors. The present invention addresses at least this need.

### BRIEF SUMMARY

This summary is provided to describe select concepts in a simplified form that are further described in the Detailed Description. This summary is not intended to identify key or essential features of the claimed subject matter, nor is it intended to be used as an aid in determining the scope of the claimed subject matter.

In one embodiment, a two degree-of-freedom motor includes an inner stator, a plurality of inner stator windings, an inner rotor, an outer stator, a plurality of outer stator windings, an outer rotor, and a shaft. The inner stator has a plurality of radially outwardly extending inner stator poles. The inner stator windings are wound around the inner stator poles and are operable, upon being energized, to generate a first magnetic field. The inner rotor is spaced apart from, and at least partially surrounds, the inner stator. The inner rotor includes a plurality of magnets and is mounted for rotation about a first rotational axis. The outer stator is spaced apart from, and at least partially surrounds, the inner stator and the inner rotor. The outer stator has a plurality of radially inwardly extending outer stator poles. The outer stator windings are wound around the outer stator poles and are operable, upon being energized, to generate a second magnetic field. The outer rotor is spaced apart from, and is disposed between, the inner rotor and the outer stator. The outer rotor has a plurality of radially outwardly extending outer rotor projections. The outer rotor is mounted for rotation about a second rotational axis that is perpendicular to the first rotational axis. The shaft is coupled to the inner rotor and the outer rotor, and is selectively rotatable with the inner rotor about the first rotational axis and selectively rotatable with the outer rotor about the second rotational axis.

In another embodiment, a two degree-of-freedom motor includes an inner stator, a plurality of inner stator windings, an inner rotor, an outer stator, a plurality of outer stator windings, an outer rotor, a shaft, and a control. The inner stator has a plurality of radially outwardly extending inner stator poles. The inner stator windings are wound around the inner stator poles and are operable, upon being energized, to generate a first magnetic field. The inner rotor is spaced apart from, and at least partially surrounds, the inner stator. The inner rotor includes a plurality of magnets and is mounted for rotation about a first rotational axis. The outer stator is spaced apart from, and at least partially surrounds, the inner stator and the inner rotor. The outer stator has a first predetermined number of radially inwardly extending outer stator poles. The outer stator windings are wound around the outer stator poles and are operable, upon being energized, to generate a second magnetic field. The outer rotor is spaced apart from, and is disposed between, the inner rotor and the outer stator. The outer rotor has a second predetermined number of radially outwardly extending outer rotor projections. The outer rotor is mounted for rotation about a second rotational axis that is perpendicular to the first rotational axis. The shaft is coupled to the inner rotor and the outer rotor, and is selectively rotatable with the inner rotor about the first rotational axis and selectively rotatable with the outer rotor about the second rotational axis. The control is in operable communication with the inner stator windings and the outer stator windings. The control is configured to controllably supply current to the inner stator windings and the outer stator windings. The first predetermined number is greater than the second predetermined number.

In yet another embodiment, an unmanned aerial vehicle (UAV) includes an airframe, a plurality of propellers rotatable relative to the airframe, and a plurality of two degree-of-freedom motors mounted on the airframe. Each motor coupled to a different one of the propellers and each including an inner stator, a plurality of inner stator windings, an inner rotor, an outer stator, a plurality of outer stator windings, an outer rotor, and a shaft. The inner stator has a plurality of radially outwardly extending inner stator poles. The inner stator windings are wound around the inner stator poles and are operable, upon being energized, to generate a first magnetic field. The inner rotor is spaced apart from, and at least partially surrounds, the inner stator. The inner rotor includes a plurality of magnets and is mounted for rotation about a first rotational axis. The outer stator is spaced apart from, and at least partially surrounds, the inner stator and the inner rotor. The outer stator has a plurality of radially inwardly extending outer stator poles. The outer stator windings are wound around the outer stator poles and are operable, upon being energized, to generate a second magnetic field. The outer rotor is spaced apart from, and is disposed between, the inner rotor and the outer stator. The outer rotor has a plurality of radially outwardly extending outer rotor projections. The outer rotor is mounted for rotation about a second rotational axis that is perpendicular to the first rotational axis. The shaft is coupled to the inner rotor and the outer rotor, and is selectively rotatable with the inner rotor about the first rotational axis and selectively rotatable with the outer rotor about the second rotational axis.

Furthermore, other desirable features and characteristics of the two degree-of-freedom motor, system, and aerial vehicle will become apparent from the subsequent detailed description and the appended claims, taken in conjunction with the accompanying drawings and the preceding background.

### BRIEF DESCRIPTION OF THE DRAWINGS

The present invention will hereinafter be described in conjunction with the following drawing figures, wherein like numerals denote like elements, and wherein:

FIG. 1 depicts a simplified cross-sectional view of one embodiment of a two degree-of-freedom motor;

FIG. 2 depicts a plan view (with some features depicted with transparency) of a portion of the two degree-of-freedom motor depicted in FIG. 1;

FIG. 3 a plan view of a spin motor that may be used in the two degree-of-freedom motor depicted in FIG. 1;

FIG. 4 depicts a plan view of a tilt motor (with some features depicted with transparency) that may be used in the two degree-of-freedom motor depicted in FIG. 1;

FIG. 5 depicts a plan view of a rotor that may be used in the tilt motor of FIG. 4;

FIGS. 6 and 7 plan views (with some features depicted with transparency) of a portion of the two degree-of-freedom motor depicted in FIG. 1 with the tilt motor in a non-tilted position (FIG. 6) and a tilted position (FIG. 7;

FIG. 8 depicts a functional block diagram of a multi-degree-of-freedom control system; and

FIG. 9 depicts one embodiment of an unmanned aerial vehicle that may include the two degree-of-freedom motor depicted in FIG. 1.

### DETAILED DESCRIPTION

The following detailed description is merely exemplary in nature and is not intended to limit the invention or the application and uses of the invention. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary, or the following detailed description.

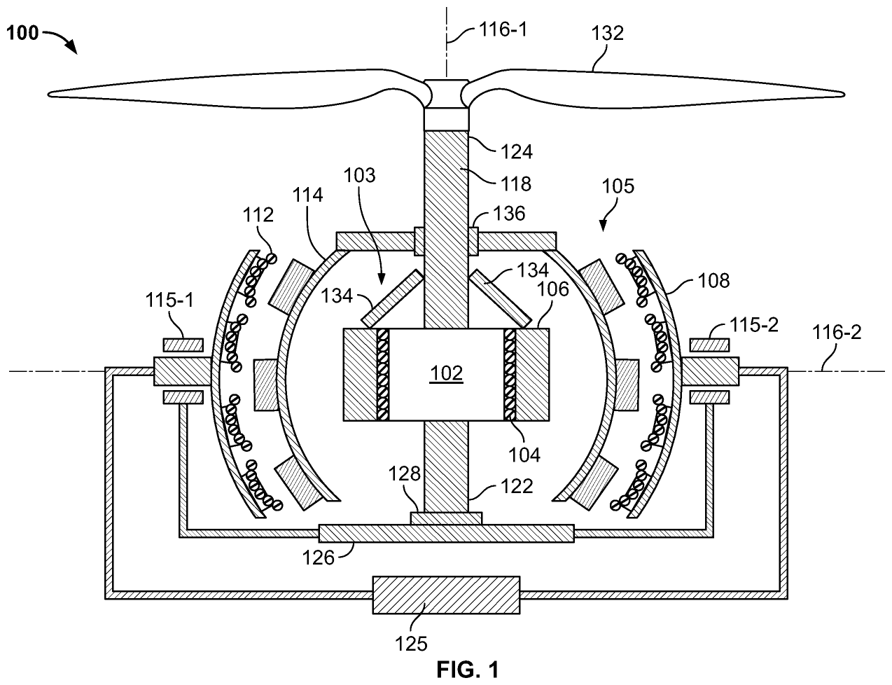

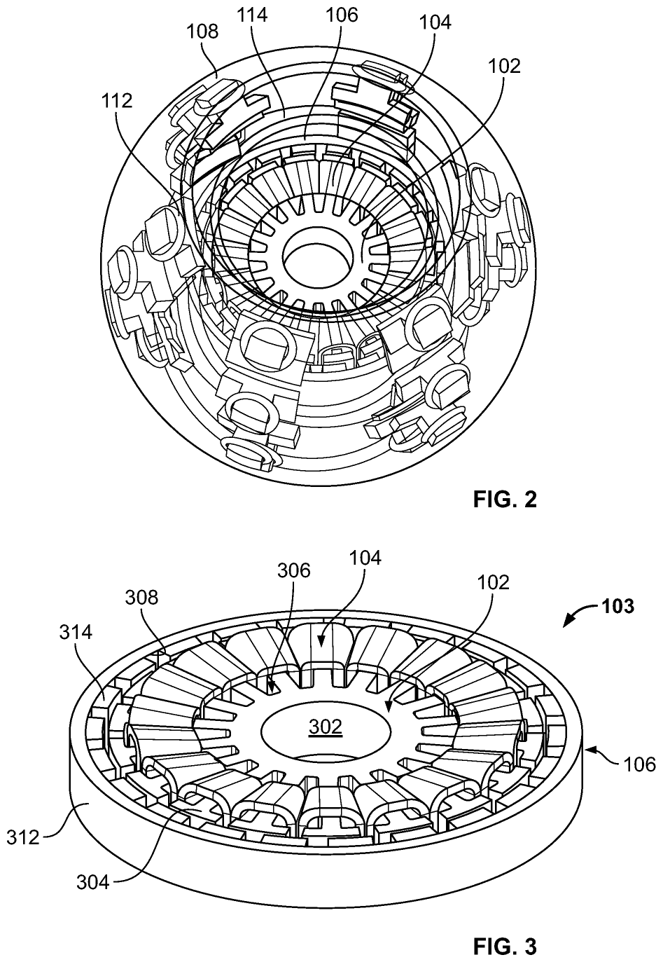

Referring to FIGS. 1 and 2, a simplified cross-sectional view and a plan view (with some features depicted with transparency), respectively, of one embodiment of a two degree-of-freedom motor 100 is depicted. As depicted therein, the motor 100 includes at least an inner stator 102, a plurality of inner stator windings 104, an inner rotor 106, an outer stator 108, a plurality of outer stator windings 112, and an outer rotor 114. As will become apparent from the description, the inner stator 102 and inner rotor 106 form a first (or “spin”) motor 103, and the outer stator 108 and outer rotor 114 form a second (or “tilt) motor 105.

The spin motor 103 is shown separated from the two degree-of-freedom motor 100, and thus more clearly, in FIG. 3. As is clearly seen therein, the inner stator 102 includes a main body 302 and plurality of inner stator poles 304. The inner stator poles 304 extend radially outwardly from the main body 302 and define a plurality of inner stator slots 306. In the depicted embodiment the inner stator 102 is implemented with 18 inner stator poles 304, and thus 18 inner stator slots 306. It will be appreciated, however, that the inner stator 102 could be implemented with more or less than this number of inner stator poles 304 and inner stator slots 306. The inner stator 102 may be formed of any one of numerous magnetic or non-magnetic materials. Preferably, however, it is formed of a magnetic material, and most preferably laminated magnetic material. Some non-limiting examples of suitable magnetic materials include any one of numerous known silicon steels, such as M19, M27, M36, and M43, or any one of numerous known alloys such as Hiperco® 50 Alloy, and ASTM A848, or any one of numerous magnetic iron materials such as DT4C, just to name a few.

Regardless of the number of inner stator poles 304 and inner stator slots 306, the inner stator windings 104 are wound around the inner stator poles 304 and extend through the inner stator slots 306. The inner stator windings 104 may be wound in either concentrated or distributed fashion within these inner stator slots 306. In the depicted embodiment, it is noted that the inner stator windings 104 are implemented as 3-phase windings. In other embodiments, however, the inner stator windings 104 may be implemented with N-number of phases, where N is an integer greater than or less than three. Regardless of the number phases, the inner stator windings 104 are operable, upon being energized, to generate a magnetic field.

With continued reference to FIG. 3, it is seen that the inner rotor 106 is spaced apart from, and at least partially surrounds, the inner stator 102. The inner rotor 106 is mounted for rotation about a first rotational axis 116-1 (see FIG. 1), and includes an inner surface 308, an outer surface 312, and a plurality of magnets 314. The magnets 314 are coupled to the inner surface 308 of the inner rotor 106 and extend radially inwardly toward the stator poles 304.). The inner rotor 106 may be formed of any one of numerous magnetic or non-magnetic materials. Preferably, however, it is formed of a magnetic material. Some non-limiting examples of suitable magnetic materials include any one of numerous known silicon steels, such as M19, M27, M36, and M43, or any one of numerous known alloys such as Hiperco® 50 Alloy, and ASTM A848, or any one of numerous magnetic iron materials such as DT4C, just to name a few.

It is noted that the depicted embodiment is implemented with 22 magnets 314. It will be appreciated, however, that this is merely exemplary and that there could be more or less than this number of magnets 314. Regardless of the specific number, each magnet 314 is preferably arranged such that the polarity of half of the magnets 314 relative to the inner stator 102 is opposite to the polarity of the other half of the magnets 314. To maximize efficiency, the magnets 314 are preferably implemented using high-grade permanent magnets. The magnets 314 could also be implemented using a Halbach array.

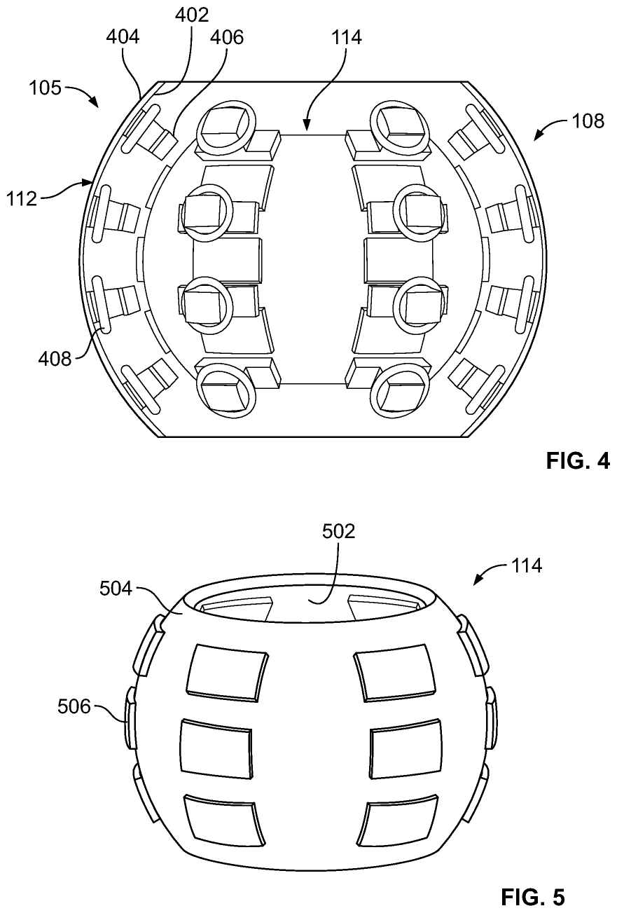

Turning now to FIG. 4, the tilt motor 105 is shown separated from the two degree-of-freedom motor 100, and thus more clearly. Before describing the tilt motor 105 in more detail, it is noted that the outer stator 108 is depicted in FIG. 4 with transparency. This is to allow inner portions of the outer stator 108, the outer stator windings 112, and the outer rotor 114 to be visible. This also helps illustrate the relative positioning of the outer stator 108 and outer rotor 114.

In any case, with quick reference back to FIG. 1, it is seen that the outer stator 108 is spaced apart from, and at least partially surrounds, the inner stator 102, the inner rotor 106, and the outer rotor 114, and is fixedly mounted to a first mount structure 125. In some embodiments, the first mount structure 125 may be, for example, an airframe of an unmanned aerial vehicle (UAV). Returning to FIG. 4, it is further seen that outer stator 108 is at least semi-spherically shaped and includes an inner surface 402, an outer surface 404, and a plurality of outer stator poles 406. The outer stator poles 406 extend radially inwardly from the inner surface 402 of the outer stator toward the outer rotor 114. The outer stator 108 is implemented with a first predetermined number of outer stator poles 406. In the depicted embodiment, the first predetermined number is 24; however, it will be appreciated that the outer stator 108 could be implemented with more or less than this number of outer stator poles 406. The outer stator 108 may be formed of any one of numerous magnetic or non-magnetic materials. Preferably, however, it is formed of a magnetic material, and most preferably laminated magnetic material. Some non-limiting examples of suitable magnetic materials include any one of numerous known silicon steels, such as M19, M27, M36, and M43, or any one of numerous known alloys such as Hiperco® 50 Alloy, and ASTM A848, or any one of numerous magnetic iron materials such as DT4C, just to name a few.

Regardless of the specific number of outer stator poles 406, it is seen that the outer stator windings 112 are wound around the outer stator poles 406 and are operable, upon being energized, to generate a second magnetic field. More specifically, the outer stator windings 112 comprise a plurality of individual coils 408 that are each wound around a different one of the outer stator poles 406. As such, when an individual coil 408 is energized, the coil 408 and outer stator pole 406 that it is wound around function as an electromagnet to generate the second magnetic field.

Again, with quick reference back to FIG. 1, it is seen that the outer rotor 114 is spaced apart from, and is disposed between, the inner rotor 106 and the outer stator 108. Now, as shown more clearly in FIG. 5, the outer rotor 114 includes an inner surface 502, and outer surface 504, and a plurality of outer rotor projections 506. The outer rotor projections 506 extend radially outwardly from the outer surface 504 of the outer rotor 114 toward the outer stator 108. The outer rotor 114 is also mounted for rotation about a second rotational axis 116-2 (see FIG. 1) that is perpendicular to the first rotational axis 116-1. The manner in which this is accomplished is described further below.

The number of outer rotor projections 506 may vary, but the number is preferably a second predetermined number that is less than the first predetermined number of outer stator poles 406. In the depicted embodiment, the second predetermined number is 18; however, it will be appreciated that the outer rotor 114 could be implemented with more or less than this number of outer rotor projections 506. It will be appreciated that each of the outer rotor projections 506 may comprises a ferrous material or each may comprise a permanent magnet.

Returning now to FIG. 1, it is seen that the two degree-of-freedom motor 100 additionally includes a shaft 118. The shaft 118 extends through the inner stator 102 and has a shaft first end 122 and a shaft second end 124. The shaft first end 122 is rotationally coupled to a second mount structure 126, via a first bearing structure 128, and is rotatable, relative to the second mount structure 126, about the first rotational axis 116-1. The second mount structure 126 is rotationally mounted on the outer stator 108, via outer rotor bearing assemblies 115 (115-1, 115-2). Thus, the shaft 118 is rotatable with the outer rotor 114 about the second rotational axis 116-2. The shaft second end 124 is coupled to a load 132. The load 132 may be implemented using any one of numerous types of loads, but in the depicted embodiment the load 132 is a propeller.

The shaft 118 is also coupled to the inner rotor 106 and to the outer rotor 114. The shaft 118 is rotatable with the inner rotor 106 about the first rotational axis 116-1 and, as just noted, is rotatable with the outer rotor 114 about the second rotational axis 116-2. In the depicted embodiment, the shaft 118 is coupled to the inner rotor 106 via mechanical fasteners 134 that are connected to the inner rotor 106 and the shaft 118 and are disposed between the outer rotor 114 and the shaft 118 and are spaced 180-degrees apart from each other. The shaft 118 is coupled to the outer rotor 114 via a second bearing structure 136 that is connected to the outer rotor 114 and the shaft 118 to allow rotation of the shaft 118 relative to the outer rotor 114. The shaft 118 is preferably formed of a non-magnetic material such as, for example, aluminum, or stainless steel, just to name a few

With the configuration described herein, when the inner stator windings 104 are energized, the generated magnetic field causes the inner rotor 106 (and thus the shaft 118) to rotate about the first rotational axis 116-1. As noted above, a load 132, such as the depicted propeller, may be coupled to the shaft 118 to receive the torque supplied therefrom. More specifically, when the inner stator windings 104 are energized with alternating current (AC) voltages, a Lorentz force is generated between the inner stator windings 104 and the magnets 314, which in turn imparts a torque to the inner rotor 106 (and thus the shaft 118) that causes it to rotate about the first rotational axis 116-1 (e.g., spin axis).

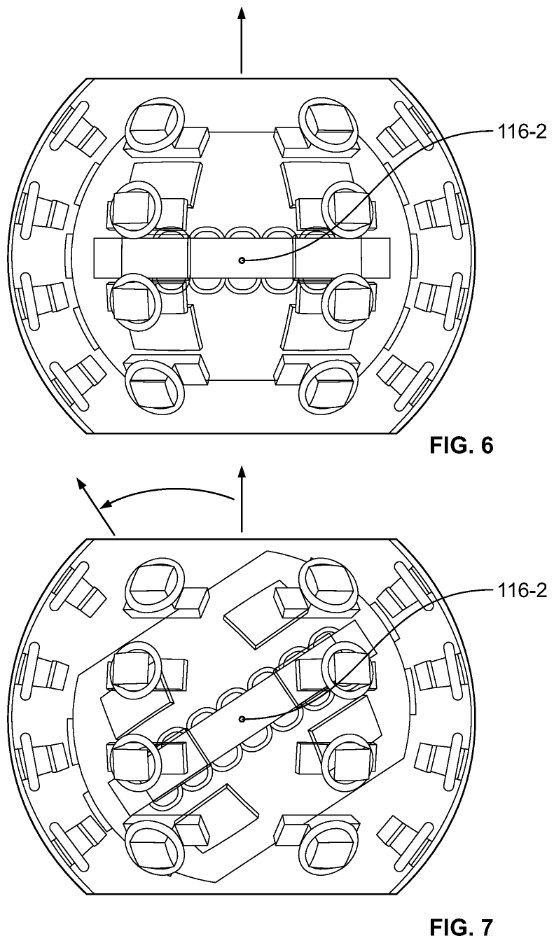

Moreover, by energizing selected ones of the outer stator windings 112, the magnetic field that is generated thereby can generate a torque on the outer rotor 114 that will cause the outer rotor 114, and thus the inner stator 102, the inner rotor 106, and the shaft 118, to rotate about the second rotational axes 116-2. More specifically, when selected ones of the individual coils 408 are energized with a DC voltage, the energized coils 408 generate a magnetic flux that attracts (or repels) adjacent outer rotor projections 506. This generates a torque on the inner rotor 114, causing it to rotate about the second rotational axis 116-2, from a normal, non-rotated position, which is depicted in FIG. 6, to a desired rotated position, such as the one depicted in FIG. 7. The magnitude and direction of the torque depends on the magnitude and direction of the input current supplied to the individual coils 408, and which individual coils 408 are being energized.

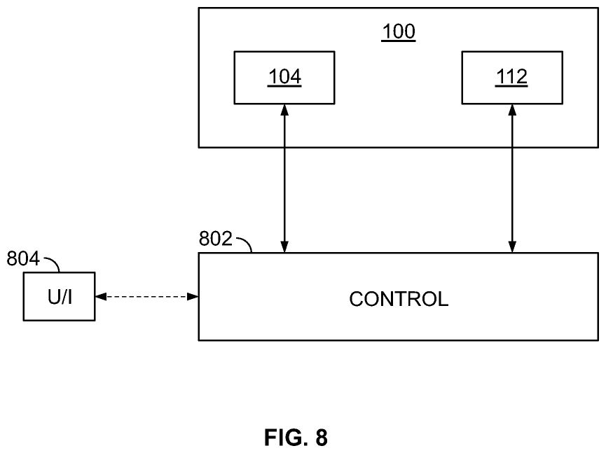

The inner and outer stator windings 104, 112 are selectively energized via, for example, a controller 802, such as the one depicted in FIG. 8. The controller 802 is coupled to the inner stator windings 104 and to the outer stator windings 112. The controller 802 is configured to control the current magnitude and direction supplied to each of the inner stator windings 104, to thereby control the direction and rotational speed of the inner rotor 106 about the first rotational axis 116-1, and is further configured to control the current magnitude and direction supplied to the outer stator windings 112, to thereby control the direction and rotational speed of the outer rotor 114 about the second rotational axis 116-2. The controller 802 may be configured to implement any one of numerous closed-loop or open-loop control schemes.

The two degree-of-freedom motor 100 disclosed herein provides several advantages over presently known multi-degree-of-freedom motors. For example, it generates relatively higher torque about the first rotational axis 116-1, at lower temperatures and a higher speed range. In addition, the rotation about the second rotational axis 116-2 is provided at a relatively higher precision and linearity.

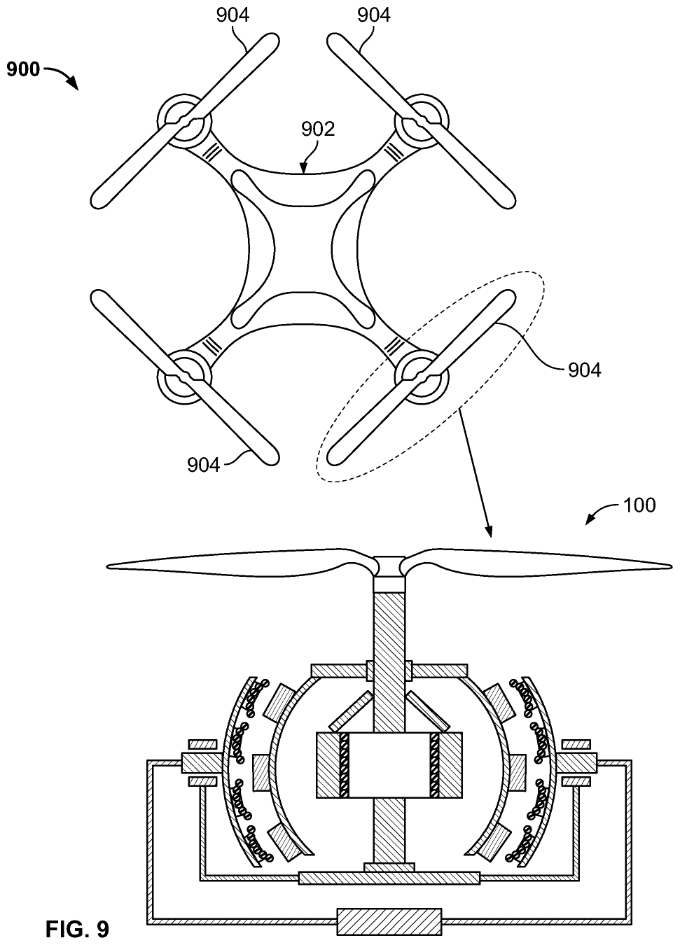

The two degree-of-freedom motor 100 depicted in FIG. 1 and described herein may be used in UAV, such as the UAV 900 depicted in FIG. 9. The UAV 900 depicted therein includes an airframe 902, a plurality of propellers 904, and a plurality of two degree-of-freedom motors 100 (only one shown). Each of propellers 904 is mounted on, and is rotatable relative to, the airframe 902. Each two degree-of-freedom motor 100 is also mounted on the airframe 902, and each is coupled to a different one of the propellers 904. The two degree-of-freedom motors 100 may be controlled via the control 802 of FIG. 8, which may be disposed on or separate from the airframe 902. If disposed separate from the airframe 902, the control 802 is configured to in wirelessly communicate with sources of power that supply the currents to the inner and outer stator windings 104, 112. If the control 802 is disposed on the airframe 902, a separate user interface device 804 may be used to supply commands to the control 902, which in turn controls the currents to the inner and outer stator windings 104, 112.

Those of skill in the art will appreciate that the various illustrative logical blocks, modules, circuits, and algorithm steps described in connection with the embodiments disclosed herein may be implemented as electronic hardware, computer software, or combinations of both. Some of the embodiments and implementations are described above in terms of functional and/or logical block components (or modules) and various processing steps. However, it should be appreciated that such block components (or modules) may be realized by any number of hardware, software, and/or firmware components configured to perform the specified functions. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. For example, an embodiment of a system or a component may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments described herein are merely exemplary implementations.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processor devices can carry out the described operations, tasks, and functions by manipulating electrical signals representing data bits at memory locations in the system memory, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

When implemented in software or firmware, various elements of the systems described herein are essentially the code segments or instructions that perform the various tasks. The program or code segments can be stored in a processor-readable medium or transmitted by a computer data signal embodied in a carrier wave over a transmission medium or communication path. The “computer-readable medium”, “processor-readable medium”, or “machine-readable medium” may include any medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or the like. The computer data signal may include any signal that can propagate over a transmission medium such as electronic network channels, optical fibers, air, electromagnetic paths, or RF links. The code segments may be downloaded via computer networks such as the Internet, an intranet, a LAN, or the like.

Some of the functional units described in this specification have been referred to as “modules” in order to more particularly emphasize their implementation independence. For example, functionality referred to herein as a module may be implemented wholly, or partially, as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices, or the like. Modules may also be implemented in software for execution by various types of processors. An identified module of executable code may, for instance, comprise one or more physical or logical modules of computer instructions that may, for instance, be organized as an object, procedure, or function. Nevertheless, the executables of an identified module need not be physically located together, but may comprise disparate instructions stored in different locations that, when joined logically together, comprise the module and achieve the stated purpose for the module. Indeed, a module of executable code may be a single instruction, or many instructions, and may even be distributed over several different code segments, among different programs, and across several memory devices. Similarly, operational data may be embodied in any suitable form and organized within any suitable type of data structure. The operational data may be collected as a single data set, or may be distributed over different locations including over different storage devices, and may exist, at least partially, merely as electronic signals on a system or network.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Furthermore, depending on the context, words such as “connect” or “coupled to” used in describing a relationship between different elements do not imply that a direct physical connection must be made between these elements. For example, two elements may be connected to each other physically, electronically, logically, or in any other manner, through one or more additional elements.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A two degree-of-freedom motor, comprising:
an inner stator having a plurality of radially outwardly extending inner stator poles;
a plurality of inner stator windings wound around the inner stator poles and operable, upon being energized, to generate a first magnetic field;
an inner rotor spaced apart from, and at least partially surrounding, the inner stator, the inner rotor comprising a plurality of magnets and mounted for rotation about a first rotational axis;
an outer stator spaced apart from, and at least partially surrounding, the inner stator and the inner rotor, the outer stator having a plurality of radially inwardly extending outer stator poles;
a plurality of outer stator windings wound around the outer stator poles and operable, upon being energized, to generate a second magnetic field;
an outer rotor spaced apart from, and disposed between, the inner rotor and the outer stator, the outer rotor having a plurality of radially outwardly extending outer rotor projections, the outer rotor mounted for rotation about a second rotational axis that is perpendicular to the first rotational axis; and
a shaft coupled to the inner rotor and the outer rotor, the shaft selectively rotatable with the inner rotor about the first rotational axis and selectively rotatable with the outer rotor about the second rotational axis.

2. The motor of claim 1, further comprising:
a plurality of shaft bearing assemblies, each shaft bearing assembly disposed between the outer rotor and the shaft to thereby allow rotation of the shaft, relative to the outer rotor, about the first rotational axis.

3. The motor of claim 1, wherein:
the outer stator comprises a first predetermined number of outer stator poles;
the outer rotor comprises a second predetermined number of outer rotor projections; and
the first predetermined number is greater than the second predetermined number.

4. The motor of claim 1, wherein each of the outer rotor projections comprises a ferrous material.

5. The motor of claim 1, wherein each of the outer rotor projections comprises a permanent magnet.

6. The motor of claim 1, further comprising:
a load coupled to the shaft and rotatable therewith about the first and second rotational axes.

7. The motor of claim 6, wherein the load comprises a propeller.

8. The motor of claim 1, further comprising:
a control in operable communication with the inner stator windings and the outer stator windings, the control configured to controllably supply current to the inner stator windings and the outer stator windings.

9. A two degree-of-freedom motor, comprising:
an inner stator having a plurality of radially outwardly extending inner stator poles;
a plurality of inner stator windings wound around the inner stator poles and operable, upon being energized, to generate a first magnetic field;
an inner rotor spaced apart from, and at least partially surrounding, the inner stator, the inner rotor comprising a plurality of magnets and mounted for rotation about a first rotational axis;
an outer stator spaced apart from, and at least partially surrounding, the inner stator and the inner rotor, the outer stator having a first predetermined number of radially inwardly extending outer stator poles;
a plurality of outer stator windings wound around the outer stator poles and operable, upon being energized, to generate a second magnetic field;
an outer rotor spaced apart from, and disposed between, the inner rotor and the outer stator, the outer rotor having a second predetermined number of radially outwardly extending outer rotor projections, the outer rotor mounted for rotation about a second rotational axis that is perpendicular to the first rotational axis;
a shaft coupled to the inner rotor and the outer rotor, the shaft selectively rotatable with the inner rotor about the first rotational axis and selectively rotatable with the outer rotor about the second rotational axis; and
a control in operable communication with the inner stator windings and the outer stator windings, the control configured to controllably supply current to the inner stator windings and the outer stator windings,
wherein the first predetermined number is greater than the second predetermined number.

10. The motor of claim 9, further comprising:
a plurality of shaft bearing assemblies, each shaft bearing assembly disposed between the outer rotor and the shaft to thereby allow rotation of the shaft, relative to the outer rotor, about the first rotational axis.

11. The motor of claim 9, wherein each of the outer rotor projections comprises a ferrous material.

12. The motor of claim 9, wherein each of the outer rotor projections comprises a permanent magnet.

13. The motor of claim 9, further comprising:
a load coupled to the shaft and rotatable therewith about the first and second rotational axes.

14. The motor of claim 13, wherein the load comprises a propeller.

15. An unmanned aerial vehicle (UAV), comprising:
an airframe;
a plurality of propellers rotatable relative to the airframe; and
a plurality of two degree-of-freedom motors mounted on the airframe, each two degree-of-freedom motor coupled to a different one of the propellers, each of the two degree-of-freedom motors comprising:
an inner stator having a plurality of radially outwardly extending inner stator poles;
a plurality of inner stator windings wound around the inner stator poles and operable, upon being energized, to generate a first magnetic field;
an inner rotor spaced apart from, and at least partially surrounding, the inner stator, the inner rotor comprising a plurality of magnets and mounted for rotation about a first rotational axis;
an outer stator spaced apart from, and at least partially surrounding, the inner stator and the inner rotor, the outer stator having a plurality of radially inwardly extending outer stator poles;
a plurality of outer stator windings wound around the outer stator poles and operable, upon being energized, to generate a second magnetic field;
an outer rotor spaced apart from, and disposed between, the inner rotor and the outer stator, the outer rotor having a plurality of radially outwardly extending outer rotor projections, the outer rotor mounted for rotation about a second rotational axis that is perpendicular to the first rotational axis; and
a shaft coupled to the inner rotor, the outer rotor, and one of the propellers, the shaft selectively rotatable with the inner rotor about the first rotational axis and selectively rotatable with the outer rotor about the second rotational axis.

16. The UAV of claim 15, wherein each motor further comprises:
a plurality of shaft bearing assemblies, each shaft bearing assembly disposed between the outer rotor and the shaft to thereby allow rotation of the shaft, relative to the outer rotor, about the first rotational axis.

17. The UAV of claim 15, wherein each motor further comprises:
the outer stator of each motor comprises a first predetermined number of outer stator poles;
the outer rotor of each motor comprises a second predetermined number of outer rotor projections; and
the first predetermined number is greater than the second predetermined number.

18. The UAV of claim 15, wherein each of the outer rotor projections comprises a ferrous material.

19. The UAV of claim 15, wherein each of the outer rotor projections comprises a permanent magnet.

20. The UAV of claim 15, further comprising:
a control in operable communication with each of the inner stator windings and each of the outer stator windings, the control configured to controllably supply current to each of the inner stator windings and each of the outer stator windings.
